(19) United States
(12) Patent Application Publication
(10) Pub. No.: US 2002/0099666 A1
(43) Pub. Date: Jul. 25, 2002

(54) System for maintaining the security of client files

(76) Inventors: Joseph E. Dryer, Houston, TX (US); John David Lambert, Katy, TX (US)

Correspondence Address: JOSEPH E. DRYER, 10307 SUGAR HILL DRIVE, HOUSTON, TX, 77042, US

(21) Appl. No.: 10/007,893

(22) Filed: Nov. 13, 2001

Related U.S. Application Data
(60) Provisional application No. 60/252,720, filed on Nov. 22, 2000.

(51) Int. Cl. H04K 1/00

(52) U.S. Cl. 705/71

(57) ABSTRACT

Embodiments of the invention provide a high degree of security to a computer or several computers connected to the Internet or a LAN. Where there is a high degree of confidentiality required, a combination of hardware and software secures data and provides some isolation from the outside network. An exemplary hardware system consists of a processor module, a redundant non-volatile memory system, such as dual disk drives, and multiple communications interfaces. This security system must be unlocked by a passphrase to access data, and all data is transparently encrypted, stored, archived and available for encrypted backup. A system for maintaining secure communications, file transfer and document signing with PKI, and a system for intrusion monitoring and system integrity checks are provided, logged and selectively alarmed in a tamper-proof, time-certain manner. The encryption keys can be automatically sent encrypted to be escrowed with a secure party to allow recovery.

### CROSS-REFERENCE TO RELATED APPLICATIONS

This application claims benefit of United States provisional patent application Ser. No. 60/252,720, filed Nov. 22, 2000, which is herein incorporated by reference.

### TECHNICAL FIELD OF THE INVENTION

This invention generally relates to data processing. More particularly, embodiments of the invention relate security provisions for on-line communications as well as secure data storage.

### BACKGROUND OF THE INVENTION

When the computer replaced the file cabinet as the storage place for documents there remained the threat to these documents of physical loss through theft or destruction as by fire or flood. In addition the computer added its own methods of destruction of data as by file corruption, computer virus or disk crash. Most corporations also maintain system administration that allows system administrators to have access to most computer data. Not only does this imply trust in the department with administrator or root authorization, but also the object of most computer hacking is to obtain this level of authorization, and this is often accomplished. Operating with user or administrator authorization in a user's computer allows file deletion and modification and could allow disk formatting, emailing of any file to outside parties, and modification of the computer's security settings. This is difficult to overcome in a computer without restricting the normal secure functioning of the computer, since the attacker can often attain the ability to perform any function a legitimate user of the computer can perform. Common email communications of this sensitive information is in plain text and is subject to being read by unauthorized code on the senders system, during transit and by unauthorized code on the receiver's system.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 shows a high level diagram of an embodiment of a security device, termed a Lockbox, coupled to an end user's computer (PC) and to a network (e.g., a LAN). Information from the PC is transferred to the security device where the information is encrypted and stored. Illustratively, information is distributed according to client in order to be available for customer viewing over a secure socket. However, the Lockbox also supports standard file structures and can store any normal computer folders.

FIG. 2 shows one use of the Lockbox where a routable static IP address is available to allow the Lockbox to act as a web host to provide enhanced data security and secure communications for a small office environment.

FIG. 3 shows an alternative embodiment of the Lockbox as a security and storage system in which files enciphered by an owner's security device are duplicated on a remotely located third-party ISP host. The host provides access restricted to authorized users.

FIG. 4 shows an alternative embodiment of the Lockbox as a security and storage system in which the computer to be secured is located within a corporate LAN. While providing the data security inherent in the Lockbox, the communications security is provided by an encrypted standardized Internet service to either another Lockbox or to a secure third party server with customized software.

FIG. 5 shows a client file as viewed by the client under a secure socket connection. This illustrates the client's ability to view all documents in the folder, to digitally sign selected documents and to securely return documents with comments. This illustratively shows a client file established by “Tom Owner” for viewing by “James Client”.

### SUMMARY OF THE INVENTION

To address these problems this invention proposes to offer the computer owner a system establishing a comprehensive security system. Where there is a high degree of confidentially required, a combination of hardware and software secures that data. Running software with a restricted operating system on a separate processor allows security of stored files that cannot be corrupted by commands from a compromised host system. An exemplary hardware system, referred to in this application as a “Lockbox”, consists of a processor module, a redundant non-volatile memory system such as dual hard disks, power conditioning and multiple communications interfaces. The Lockbox is connected by a Local Area Network link to a protected computer or computers. On power-up the Lockbox data is inaccessible until the Lockbox is connected to the appropriate networks and unlocked by a passphrase from a protected computer. After unlocking, the Lockbox can provide files to only a protected computer. The Lockbox regularly archives its files. Data stored in the Lockbox is encrypted before storage and decrypted before delivery to a protected computer transparently to a user. Files delivered to client folders in the Lockbox will trigger an email to the client notifying them of the availability of a communication. The client can only access his folder by establishing a secure socket connection and thereby viewing, digitally signing or modifying the client file contents. Security is further enhanced by a firewall, various system integrity checks, and intrusion detection, all of which log incidents and, if the incident is sufficiently serious, alarms the user. These logs and alarms cannot by disabled by any commands from the host system.

### DETAILED DESCRIPTION OF THE PREFERRED EMBODIMENTS

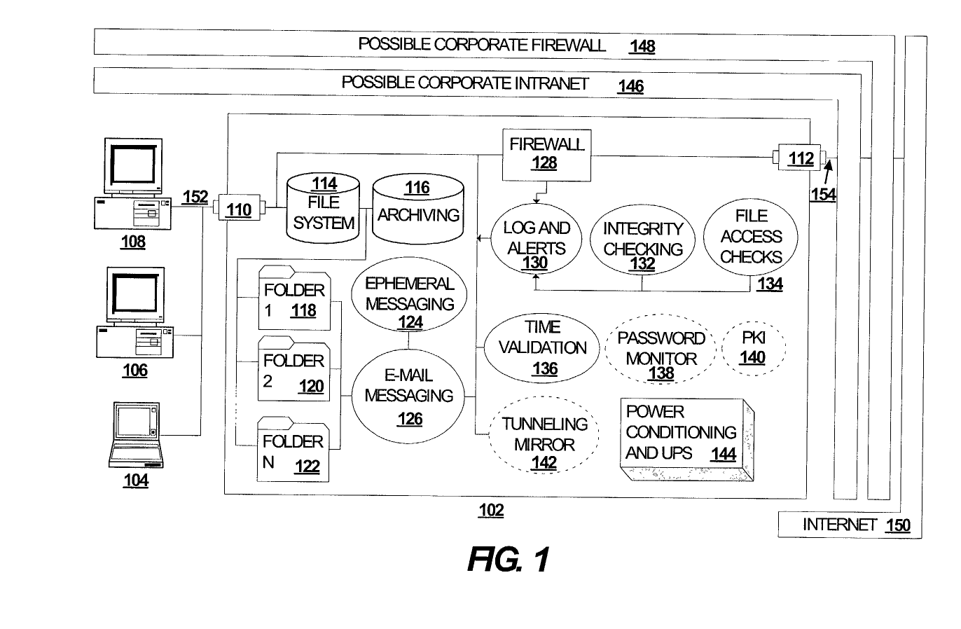

An exemplary configuration of a Lockbox is illustrated in FIG. 1. The Lockbox enclosure 102 includes power conditioning and UPS 144 and two Ethernet ports 110 and 112 for connection to a protected subnet 150 and to an outside network 151, respectively. The outside network 151 can be either an outside intranet 146 or the Internet 150. When an Intranet 146 is employed this customarily connects through a firewall 148 to the Internet 148. The protected subnet 150 connects to one or more protected user computers represented by 104, 106 and 108 by Ethernet connections with any required switches, etc. not shown. Within the Lockbox 102 an encrypted file system 114 encrypts and decrypts on-the-fly Ethernet communications between the protected computers 104-106 and the internally stored encrypted data. The files stored in 114 are regularly archived in 116 to provide file access if malicious code in a protected computer erases or alters a file in 114. The file system 114 also organizes client folders exemplified by 118, 120 and 122 in additional to regular files. As shown in the progression from 120 to 122, there can be an indefinite number of client folders, and a client folder can represent a group of clients. Associated with a client folder are files to be sent to the client, files received from the client, and client information such as client password, email address and digital signature public and private key. A computer task 126 scans for changes in the client folders and sends emails to the client or to the user on receipt of a file to be sent to the client or received from the client, respectively. Another task 124 can be activated to purge a sent message from the system once the client has retrieved it. All incoming and outgoing communications to the outside network 151 passes through an internal firewall 128 to provide a layered security to the protected subnet 150 and to the Lockbox. Traffic is monitored by the firewall 128 and reported to a logging task 130 which also has input from internal integrity checks 132, which monitors the physical condition of the Lockbox, the functioning of its components, invalid access attempts, and the file access monitor 134. The file access monitor 134 detects attempts to access selected files as an additional intrusion monitor. The time is continually monitored over the Internet by a task 136 that insures the accuracy of the time stamps in the logs. Any failure of this task is alerted. Any changes in passphrases can be optionally detected by a task 138 to trigger encrypted exchange with a trusted party to escrow the change. In association with the client folders a task 140 can optionally provide a Public Key Infrastructure for the internally stored digital signatures. A task is provided for organizing a network tunneling system 142 to allow secure encrypted communications with ordinary Internet communications protocol to associated software on an outside computer on the Intranet 146 or the Internet 150. This monitors the encrypted file system 114 to detect changes and, if the change is in a selected file, to coordinate a change in the outside computer to mirror those changes. Conversely, changes in the mirrored files in the outside computer are reflected to 114.

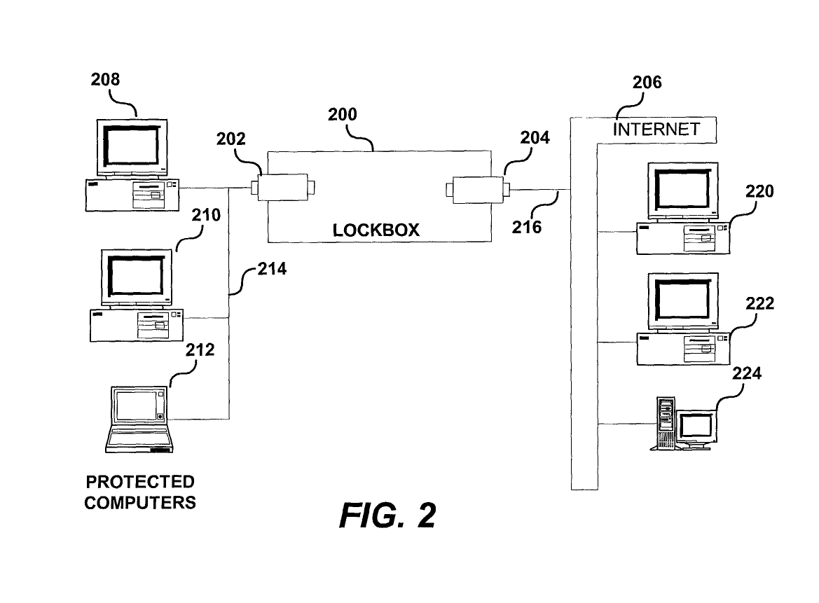

FIG. 2 illustrates the Lockbox connected to an Internet connection 216, which would normally be a routable, static IP address, through the Lockbox outside port 204. The Lockbox 200 incorporates the features of 102 in FIG. 1. The Lockbox communicates over the Internet 206 to client boxes on the Internet as illustrated by 220 and 222. The Lockbox can also communicate to a mirrored outside computer 224 with tunneling mirror software to provide data backup. The Lockbox connects via its Ethernet connection 202 to a protected subnet 214 and from there to one or more protected computers as illustrated by 208, 210 and 212.

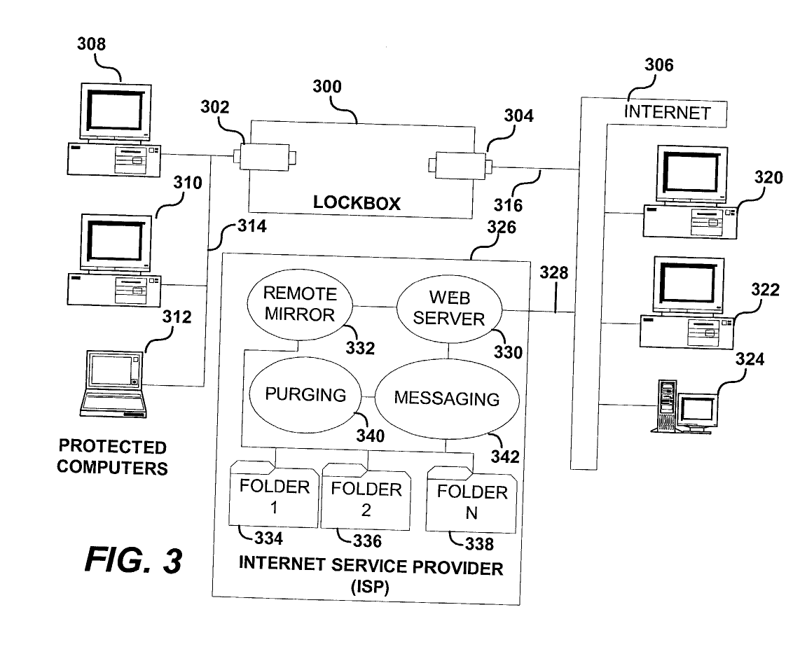

FIG. 3 illustrates the possibly of securely exporting the function of providing the secure email notification to an outside Internet Service Provider (ISP) using the tunneling mirror service. This is useful if a static, routable IP address is not available to the Lockbox at its connection 316. Elements 300 to 324 correspond to elements 200 through 224 in FIG. 2, respectively. The ISP 326 is also connected to the Internet 328. The ISP 326 contains a web server 330 that connects to a mirrored remote client box 332 with software corresponding to the tunneling mirror software 142 in FIG. 1. This software negotiates an encrypted communication with 142 to mirror the client folders in the Lockbox (118 through 122 in FIG. 1) to mirrored folders in the ISP illustrated by 334, 336 and 338. Changes in the folders detected by task 342 trigger emails to the client to allow retrieval through a secure socket communication to the ISP. The client, when accessing his folder through the secure socket, can add files to his folder or digitally sign the files in his folder and the mirroring task 332 will communicate this information to the equivalent folders in the Lockbox 300 to allow update of those files by task 142 in FIG. 1. Task 340 allows purging of the client's selected files on retrieval by the client.

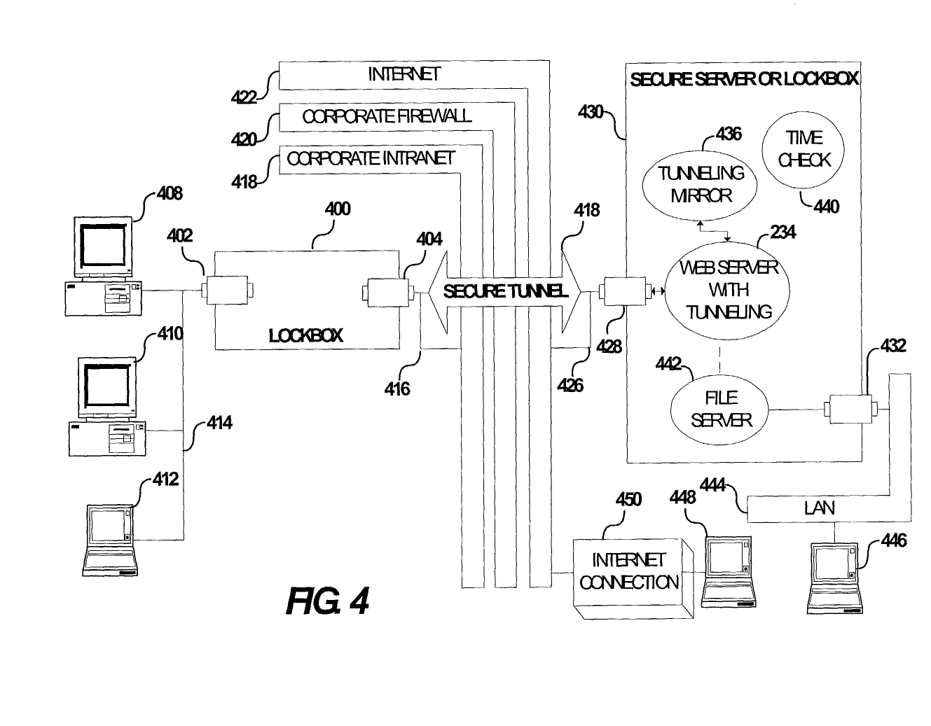

FIG. 4 illustrates the use of a Lockbox 400 within a local area network such as a company's Intranet 418. Such an Intranet is usually accompanied by a firewall or firewalls 420 to limit access to the Internet 422. In such a configuration the Lockbox 400 serves to provide a layered protection to the protected subnet 414 and the protected computers connected on that subnet such as 408, 410 and 412. Connection is made to the protected subnet 414 through the Ethernet connection 402. The Ethernet connection to the outside world 404 serves both as a connection to the Intranet and as a method of providing the tunneling of encrypted Internet standard protocol messages containing information on the files to be mirrored. These tunneled messages 418 can pass through the corporate intranet 418 and firewall 420 to another server 430 located externally on the Internet or locally on the Internet. The server 430 contains an Ethernet port 428 that serves both as an ordinary Internet connection 426 and as a recipient for the tunneled Internet messages 418. Another Lockbox could function as the server 430. In the server, task 234 is a web server with the file decryption, functioning as 114 in FIG. 1. The tunneling mirror task 436 mirrors selected files in the Lockbox in communication with task 142 in FIG. 1. To insure accurate file coordination there is an accurate, web-based time synchronizing task 440 in the server corresponding to task 136 in FIG. 1. Optionally the server could have a file server 442 to connect to a local area network at the server's location via an Ethernet port 432. This would be useful if the Lockbox 400 is serving consultants on computers 408 through 412 who want to make their local files available to operators at their office on computers such as 446 over their home office local area network 444. In such a configuration the Lockbox would serve to protect the confidentiality of the consultant's files from the corporate network 418, protect the consultant's computers 408 thru 412 from attacks from the Intranet 418, and provide physical security to those files through the encrypted file system. Clients and co-workers such as 448 can log on the Internet through an ordinary Internet access 450 to view selected files in client folders over a secure socket connection.

In a particular embodiment, a file in the Lockbox is shared with a protected computer using standard file sharing. The Lockbox data will therefore appear as another folder or disk drive to an unmodified protected computer. The Lockbox maintains its own encryption of stored data with an internal symmetric encryption key. This insures that the encryption cannot be compromised by data stored on the protected computer. This data in the Lockbox will be unintelligible to anyone having physical possession of the Lockbox or having direct access to the files on the Lockbox. The data stored on the Lockbox is regularly archived to a second disk, with software to coordinate the data archiving and check the integrity of each storage device. In the case of a storage failure, as in a disk crash, the files are maintained in the uncorrupted storage and the user is notified that the corrupted drive must be replaced. On replacement, the data is restored to both drives and operation continues uninterrupted. The archiving of data rather than a straight backup allows data recovery in case an attacker on a protected computer directs the deletion of files. An attacker would not be able to reformat the Lockbox drives since this level of control is not available to a protected computer.

To ensure that the data is available in the case of a complete physical destruction of the host computer and Lockbox, as in the case of the destruction of the building by fire, the software includes the ability to externally archive the data on a periodic basis. The archive files contain a software wrapper containing non-sensitive information such as the date on which the data is to be allowed to expire. In one embodiment, the file name and all data in the file will be encrypted under a second encryption key, and in another embodiment the name will be unencrypted to allow file searching of the encrypted data.

Files are archived, either incrementally or by a total memory dump, into local or remote storage. Locally, the archival will be to a removable media, located within the Lockbox or on a protected computer, such as a tape or CDROM, for off-site storage. Since the files on the storage media will be encrypted, the physical loss of the archival media will not pose any security risk since they will be unreadable without the encoding key.

In one embodiment, off-site storage is provided whereby the Lockbox is periodically and automatically backed up over a secure Internet communications channel. The Lockbox incorporates tunneling software that allows selected files to be mirrored at the off-site storage. This is accomplished by negotiating a secure channel and encrypting the information inside Internet packets which appear to intervening firewalls as normal Internet communications. These packets are unintelligible to any observer. Synchronization software is included to update any files modified between mirroring exchanges.

In any case, the archival computer would then reconstruct an image of the Lockbox's encrypted data files and keep that image available for archival retrieval. As these files are stored encrypted, they would be unintelligible to the storing agent. Once restored to the Lockbox, the user would again have unencrypted access to the files by the operation of the Lockbox's decryption ability. The files would be referenced in the archival files by their encrypted identifiers and the Lockbox owner can selectively restore them by reloading into the Lockbox for decryption.

Provision is made in the code to optionally automatically escrow to a trusted third party or internal agent the encryption key and the passphrase that unlocks the Lockbox. This will insure that the data remains unintelligible to any third-party archivist but is still available to the authorized person in the case of unforeseen circumstances such as the physical destruction of the Lockbox or the removal of the user. The separation of the encrypted data access from the key storage access is designed to prevent one party, such as the system administrator, from having access to both, and therefore access to the data. The escrow agent will maintain a public key under which the Lockbox automatically encrypts the selected access keys and emails them back to the agent. This is automatically done each time the keys are changed. In the exceptional case where the keys are lost the escrow agent will return the keys after proper authentication. The key may be stored in a symmetric encrypted form on the Lockbox pending receipt of acknowledgment from the escrow agent in order to prevent intermediate loss.

When the protected computers are located within a host local area network, a client cannot normally establish secure socket communications since such computers do not normally have a routable static IP address. In this case the mirrored remote client functionality can be provided by an associated Lockbox at a static IP address on the corporate Internet interface, or a secure server at a third party running parts of the Lockbox software, as shown in FIG. 4. The Lockbox contains code for negotiating an encryption with a correspondent computer and encrypting file transfers with that correspondent computer by embedding the encrypted data within ordinary Internet packets. This is referred to as tunneling through the Internet. The secure tunneling functionality of the Lockbox will insure the security of communications while traveling between the Lockbox and the corresponding secure server or Lockbox.

Where the Lockbox is connected to the Internet, as a customer service there can be regular scans of the interface to test for vulnerabilities. This, together with the internal system health monitor, detection of invalid logon attempts, firewall intrusion detection, and the disk integrity tests, will provide warnings of impending or actual problems. Such warnings are logged and, if of sufficient importance, alarmed to the protected computers. These logs and alarms cannot be turned off or erased by the protected computers, so an intruder has no way of masking his attacks. The logs can be cleared on an alarmed command, deleting only those logs before a predetermined time before the command. This prevents an intruder from deleting those logs that evidenced his intrusion.

Where there are several protected computers with a need to access files while maintaining separate confidentiality, and confidentiality from each other, the system could use traditional restricted shared file access to provide separate user areas.

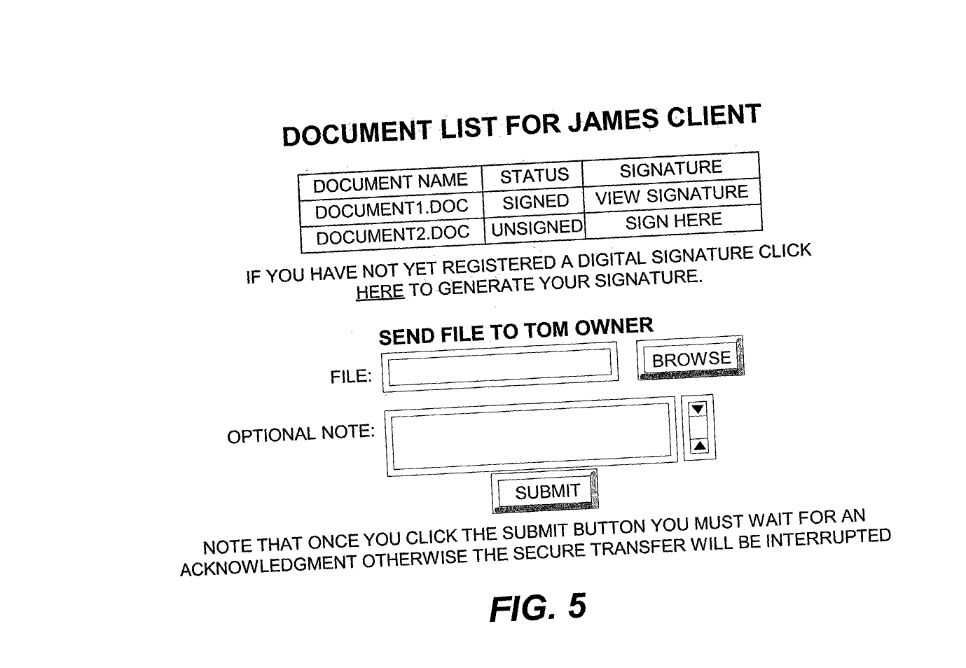

The Lockbox includes a web server with a passphrase-protected, secure socket viewing of client folders. The user sets up the client folders to be accessible for a particular set of users names and associated passphrases and digital signatures. This would allow the client secure access to documents selected by the secure computer owner as accessible for that user and password, and the ability to securely return documents. FIG. 5 shows one example of such a client view of the documents and shows one example of client options. The establishment of the documents, the notice to the client of the availability of the documents, and the access by the client to the documents would all be logged and be archived to address any subsequent issues of failure to communicate. Notice would be sent to the Lockbox owner of documents available to the client for whom no access attempts were made within some established period. The communications with the client may also include provision for digital signatures of client documents, using, for example, the Digital Signature Standard (DSS) to allow client authorization of documents. Optionally notice would be sent to the Lockbox owner if selected documents were not signed within an established period. Forms are included that negotiate with the client a passphrase for message retrieval and to establish a passphrase for a client's digital signature. The passphrase for message retrieval can be shared with the secure computer user, but the passphrase for the digital signature is not shared with the Lockbox owner. The private key for the digital signature is internally stored and is inaccessible by any party, being only used internally within the Lockbox to generate a document signature. A letter describing the reliance on the digital signature, one example of which is shown in Table 1, is sent to the client for his signature and witnessing, and is to be returned to the secure computer owner as possible evidence of detrimental reliance. This system is the internal Public Key Infrastructure (PKI).

TABLE I
This document acknowledges the establishment of a digital signature with the accompanying
public key. The undersigned acknowledges that this key was generated with the undersigned's
password. In the future (****Insert Attorney's name****) will rely on digital signatures
generated by you using this password as evidence of your approval and having under some
statutes the same force and effect as a written signature.*
In accepting the validity of this digital signature, you understand that (****Insert Attorney's
name****) has no access to your private (signing) key without your giving (*****him or
her*****) your pass phrase. The pass phrase should not be shared with anyone to whom you do
not wish to give signing authority. You have chosen (*****to have/not to have*****) an email
sent to you confirming every signing. The association between the key and the pass phrase is
inaccessible and in case of accidental disclosure of the pass phrase (****Insert Attorney's
name****) should be immediately notified so the pass phrase can be deactivated and a new
digital signature and pass phrase generated. This signature will be cancelled on your written
request to prevent use after cancellation.
Acknowledged on (*****insert date****),
\overline{OWNER OF DIGITAL SIGNATURE }
\overline{ATTORNEY SPONSOR OF DIGITAL SIGNATURE }
\overline{WITNESS }
*e.g. Texas Business & Commerce Code, amending Ch. 9 (U.C C., Art. 9) (1999 Texas Senate Bill 1058); 2001 Texas House Bill 1201 (pending); Electronic Signatures in Global and National Commerce Act

Because the time stamping of the logs is critical to proper interpretation of the sequence of events surrounding an incident, the Lockbox includes in its software the ability to regularly correct its internal clock to a standard available via the Internet. If desired, the Lockbox can regularly or on demand communicate with a third party source to establish to communicate the results of its diagnostics and possible need for maintenance. To provide evidence of intrusions, the passphrase to unlock the Lockbox and to access files can use a letter of the day or of the month (e.g. third letter of the day or second letter of the month) so that any captured passphrases will eventually become invalid, triggering an access alarm.

A logging system keeps track of all communications, the firewall transactions, the unlocking attempts, file access to selected files, client folder transactions and timeouts, root access to the Lockbox operating system, and system parameters such as power supply levels, system temperatures, disk errors, etc. The time stamping of this log is kept accurate by the internal clock. No user can delete the logs without a non-avoidable delay and an alarming of the log deletion event. Significant events in the log are also alarmed to the user.

While the foregoing is directed to embodiments of the present invention, other and further embodiments of the invention may be devised without departing from the basic scope thereof, and the scope thereof is determined by the claims that follow.

What is claimed is:

1. A system for enhancing the security of a computerized device, comprising:
a microprocessor-based Lockbox system in communication with the computerized device and through which all communications to the computerized device are routed through an internal firewall, a secure web server, with on-the-fly data encryption means for encryption of data between the computerized device and the Lockbox system allowing only encrypted data to be stored more than transitorily on the Lockbox system, and with on-the-fly decryption of the encrypted data; and
the data communication with the computerized device is possible only after passphrase enabling of the Lockbox from the computerized device and where the computerized device can disable this enabling until the next passphrase enabling.

2. The system of claim 1 wherein:
the computerized device is configured to segregate the encrypted data into client boxes and has the ability to designate some of that data for Internet communication; and
the Lockbox system is configured to provide an internet communication to the intended recipient informing the recipient of the availability of the data; and establish a secure socket communication with the recipient where, under passphrase access, the designated data can be copied by the recipient and files from the recipient can be received.

3. The system of claim 2 wherein the Lockbox is configured for secure time-stamped logging of the recipient-initiated communication of the data in a form that can only be altered by the computerized device for those logs before a predetermined time prior to the command.

4. The system of claim 2 wherein the Lockbox contains an application program to negotiate an encrypted communications over normal Internet communications with companion software on an external computer, with said application program having the ability to monitor the Lockbox data and exchange encrypted data with the companion software to mirror the Lockbox data in the external computer and to maintain mirrored files as the Lockbox and external mirrored files are changed.

5. The system of claim 2 wherein the external computer companion software then having the ability to provide an internet communication to the intended recipient informing the recipient of the availability of the data; and establish a secure socket communication with the recipient where, under passphrase access, the designated data can be copied by the recipient and files from the recipient can be received and the function of backing up the Lockbox files.

6. A system for enhancing data integrity and security and facilitating secured network communications, the system comprising:
a dedicated processing system comprising a processor, memory, redundant non-volatile storage (fixed or removable), an Internet or local area network interface with a firewall and a local network interface; wherein the memory contains at least:
an operating system which can restrict the Internet access to the local network interface and restrict the downloading and running of applications not loaded at setup;
applications programs which, when executed by the processor, allow a computer on the local network interface to securely log onto the dedicated processing system to download and upload files to and from the non-volatile storage in a manner wherein the files are encrypted while stored on the non-volatile storage; and
applications programs which, when executed by the processor, are configured to insure files are archived redundantly and are able to be retrieved in the event of normal media failure or recent deletion.

7. A system as in claim 6 wherein selected file accesses, attempted system intrusions, system operating status and firewall transactions are time-stamped with a time referenced to a reliable source and recorded in encrypted form so that the record cannot be modified without extraordinary measures, and that a record is kept of all extraordinary measures.

8. A system as in claim 6 where a passphrase to unlock the system for system access may contain a letter from the month or day so as to cause the passphrase to be non-static so as to trigger a logged invalid system access.

9. A system as in claim 6 wherein the memory further contains an applications program configured to identify clients and associate files with those client accounts so that emails are automatically sent to the clients alerting them to the pending files in their accounts.

10. A system as in claim 9 wherein when the client accesses their account in response to a notification, access to that account is restricted by pass-phrase and the communication is secured by encryption.

11. A system as in claim 10 where by means of a tunneling mirror of the Lockbox files to a remote computer the remote computer can perform for the Lockbox the functions an internet communication to the intended recipient informing the recipient of the availability of the data; and establish a secure socket communication with the recipient where, under passphrase access, the designated data can be copied by the recipient and files from the recipient can be received and the function of backing up the Lockbox files.

12. A system as in claim 10 wherein when the client accesses his account and a selected file, that file is purged from the Lockbox.

13. A system as in claim 9 wherein the memory further contains an applications program configured to allow the client to acknowledge the file contents by a digital signature with the dedicated processor managing a PKI (Public Key Infrastructure) with no external access to the private key for the signature.

14. A system as in claim 13 wherein the PKI is managed to allow files transmitted over the Internet to be digitally signed with the private key inaccessible externally.
